(19) United States
(12) Patent Application Publication
(10) Pub. No.: US 2026/0167209 A1
(43) Pub. Date: Jun. 18, 2026

(54) PARK SOCKET FOR DRIVE-OFF PREVENTION

(71) Applicant: Timothy Daniel Dunn, Falconer, NY (US)

(72) Inventor: Timothy Daniel Dunn, Falconer, NY (US)

(21) Appl. No.: 19/416,248

(22) Filed: Dec. 11, 2025

Related U.S. Application Data
(60) Provisional application No. 63/733,890, filed on Dec. 13, 2024.

(51) Int. Cl. B60W 50/00; B60D 1/62; B60W 10/06; B60W 10/10; B60W 10/18; B60W 50/14

(52) U.S. Cl. CPC B60W 50/0098; B60D 1/62; B60W 10/06; B60W 10/10; B60W 10/18; B60W 50/14

(57) ABSTRACT

Provided herein are park socket systems for drive-off prevention having a park socket positioned on a tractor and sized to receive a trailer-side connector plug of a connector cable and/or a trailer-side pneumatic coupling of a pneumatic line, a socket sensor configured to detect a presence or absence of the trailer-side connector plug and/or the trailer-side pneumatic coupling in the park socket, and a tractor controller configured, responsive to a detected absence of the trailer-side connector plug and/or the trailer-side pneumatic coupling within the park socket, to restrict movement of the tractor.

### CROSS REFERENCE TO RELATED APPLICATIONS

This application claims benefit under 35 U.S.C. § 119(e) of U.S. Provisional Application No. 63/733,890, filed on 13 Dec. 2024, entitled “PARK SOCKET FOR DRIVE-OFF PREVENTION,” the entirety of which is incorporated by reference herein.

### BACKGROUND

The heavy truck (Class 7 and Class 8) market has a standardized connector plug used for connector cables coupling the tractor (semi-truck) to the trailer. One standardized requirement of such connector plugs is that, if enough force is applied, the connector lock will release and disconnect the plug (“breakaway”) to prevent damage to the plug and socket in the event that a driver forgets to remove the plug when disconnecting from (“dropping”) a trailer. This scenario, shown in FIG. 1, where the tractor drives away while still connected to the trailer is also referred to as a “drive-off”.

However, such breakaway function is not a guarantee of damage avoidance. As shown in FIG. 2, regardless of whether breakaway function is provided, there is also risk associated with improper storage of the connector (e.g., a disconnected breakaway connector plug). In practice, improperly stored cables can hang freely, potentially dragging on the ground/roadway, impacting tractor components, and/or becoming entangled with other tractor components or cables.

In addition, in order to meet the need for increased data connectivity and speed, increased electric power needs, and other modern functionalities, the heavy truck market is investigating replacing the current standardized connector with a new design including data connections and other added connectors to support such modern functionalities. However, because these new data connections and other added connectors are generally smaller and more delicate, they require a more rigid connector to prevent damage to the pins (e.g., from vibration) and also require tighter locking between the connector plug and the corresponding socket. Therefore, any new connector design is unlikely to have the ability to provide the same “breakaway” function as the current standardized connector.

Still further, improperly stored cables can also be exposed to potentially damaging environmental elements such as water, salt, sand, dirt, grease, etc., which can cause reduced performance due to a lack of cleanliness, corrosion, and premature wear and tear on the connector plugs. These environmental elements are likely to be even more impactful on the planned new data connections and connectors for modern functionalities than the existing standard electrical plug contacts and socket pins.

Furthermore, similar to the connector cables and plugs, pneumatic lines such as brake lines and their corresponding pneumatic connectors have a limited breakaway function (e.g., via gladhands) but are also similarly susceptible to drive-off damage, as well as similar negative impacts from environmental exposure due to improper storage.

### SUMMARY

Provided herein are park socket systems for drive-off prevention that provide one or more park sockets on the tractor configured to receive and house a trailer-side plug of a connector cable and/or a trailer-side pneumatic coupling of a pneumatic line after disconnection from a trailer. The park socket system also includes a socket sensor to detect whether the plug and/or pneumatic coupling is present in the socket. Upon detection by the socket sensor that the plug and/or pneumatic coupling is absent from the connector socket, an electronic control module of the park socket system can then restrict movement of the tractor.

In one aspect, a park socket system for drive-off prevention is provided. The system includes a park socket positioned on a tractor and sized to receive a trailer-side connector plug of a connector cable and/or a trailer-side pneumatic coupling of a pneumatic line. The system also includes a socket sensor configured to detect a presence or absence of the trailer-side connector plug and/or the trailer-side pneumatic coupling in the park socket. The system also includes a tractor controller configured, responsive to a detected absence of the trailer-side connector plug and/or the trailer-side pneumatic coupling within the park socket, to restrict movement of the tractor.

In some embodiments, the tractor controller is configured to restrict movement of the tractor by at least one of preventing a gear change of the tractor, engaging a brake of the tractor, preventing an engine ignition of the tractor, prompting a driver of the tractor to provide driver feedback confirming disconnection of the trailer-side connector plug and/or the trailer-side pneumatic coupling from a trailer to be disconnected from the tractor, prompting a driver of the tractor to provide driver feedback confirming secure disconnected storage of the trailer-side connector plug and/or the trailer-side pneumatic coupling on the tractor after disconnection from the trailer, or combinations thereof. In some embodiments, the socket sensor is one or more of directly wired to the tractor controller, connected to the tractor controller via a wired network connection, connected to the tractor controller via a wireless connection, or combinations thereof. In some embodiments, the system also includes a communication module, wherein the communication module is one or more of directly wired to the tractor controller, connected to the tractor controller via a wired network connection, connected to the tractor controller via a wireless connection, or combinations thereof. In some embodiments, the park socket is positioned on a rear exterior surface, a side exterior surface, a lower exterior surface, or an upper exterior surface of the tractor. In some embodiments, the park socket is oriented in any upward-facing, downward-facing, side-facing, rear-facing, or angled direction relative to the tractor.

In some embodiments, the trailer-side connector plug includes a plurality of trailer-side connector plug contacts. In some embodiments, the park socket includes a number of socket contacts less than, equal to, or greater than a number of the plurality of electrical contacts of the trailer-side connector plug. In some embodiments, the park socket does not include electrical contacts. In some embodiments, the park socket includes a complementary pneumatic coupling to the trailer-side pneumatic coupling. In some embodiments, the socket sensor includes one or more of a resistive element connected between at least two electrical contacts of the park socket, the resistive element and a diode connected in series between at least two electrical contacts of the park socket, an inductive sensor positioned to detect, at the trailer-side connector plug and/or the trailer-side pneumatic coupling, a magnetic proximity sensor positioned to detect the trailer-side connector plug and/or the trailer-side pneumatic coupling, a microswitch proximity sensor positioned to detect the trailer-side connector plug and/or the trailer-side pneumatic coupling, an electrical continuity tester connected to two or more electrical contacts of the park socket and/or two points on a metallic element of the trailer-side pneumatic coupling, or combinations thereof. In some embodiments, the tractor controller is configured to determine a hitched or unhitched status of a trailer to be disconnected from the tractor. In some embodiments, the tractor controller is further configured, responsive to a detected absence of the trailer-side connector plug and/or the trailer-side pneumatic coupling within the park socket and a determined hitched status of the trailer to be disconnected, to restrict movement of the tractor. In some embodiments, the trailer-side connector plug is one of a single pole plug, a dual pole plug, a seven-way plug, a thirteen-way plug, a fifteen-way plug, or a seventeen-way plug. In some embodiments, the tractor controller is a tractor-side electronic control module configured for monitoring, tracking, and/or control over one or more of engine performance, emissions, transmission operation, braking systems, safety systems, lighting systems, connectivity between the tractor and the trailer, trailer control signaling, driver clutch use, driver use of cruise control, driver braking habits, driver acceleration habits, speed, tire pressure, or combinations thereof.

In another aspect, a park socket assembly for drive-off prevention is provided. The park socket assembly includes a housing. The park socket assembly also includes a park socket positioned within the housing and sized to receive a trailer-side connector plug of a connector cable and/or a trailer-side pneumatic coupling of a pneumatic line. The park socket assembly also includes a socket sensor configured to detect a presence or absence of the trailer-side connector plug and/or the trailer-side pneumatic coupling in the park socket. The park socket assembly also includes a communication module positioned within the housing for electronic communication with a tractor controller configured, responsive to a detected absence of the trailer-side connector plug and/or the trailer-side pneumatic coupling within the park socket, to restrict movement of a tractor.

In some embodiments, the communication module is one or more of directly wirable to the tractor controller, connectable to the tractor controller via a wired network connection, connectable to the tractor controller via a wireless connection, or combinations thereof. In some embodiments, the trailer-side connector plug includes a plurality of trailer-side connector plug contacts. In some embodiments, the park socket includes a number of socket contacts less than, equal to, or greater than a number of the plurality of electrical contacts of the trailer-side connector plug. In some embodiments, the park socket does not include electrical contacts. In some embodiments, the park socket includes a complementary pneumatic coupling to the trailer-side pneumatic coupling. In some embodiments, the socket sensor includes one or more of a resistive element connected between at least two electrical contacts of the park socket, the resistive element and a diode connected in series between at least two electrical contacts of the park socket, an inductive sensor positioned to detect, at the trailer-side connector plug and/or the trailer-side pneumatic coupling, a magnetic proximity sensor positioned to detect the trailer-side connector plug and/or the trailer-side pneumatic coupling, a microswitch proximity sensor positioned to detect the trailer-side connector plug and/or the trailer-side pneumatic coupling, an electrical continuity tester connected to two or more electrical contacts of the park socket and/or two points on a metallic element of the trailer-side pneumatic coupling, or combinations thereof. In some embodiments, the socket sensor is at least partially located within the housing. In some embodiments, the housing is configured to be installed on the tractor by one or more of mechanical fasteners, adhesives, welding, or combinations thereof.

### BRIEF DESCRIPTION OF THE DRAWINGS

FIG. 1 illustrates a typical drive-off event in accordance with the prior art.

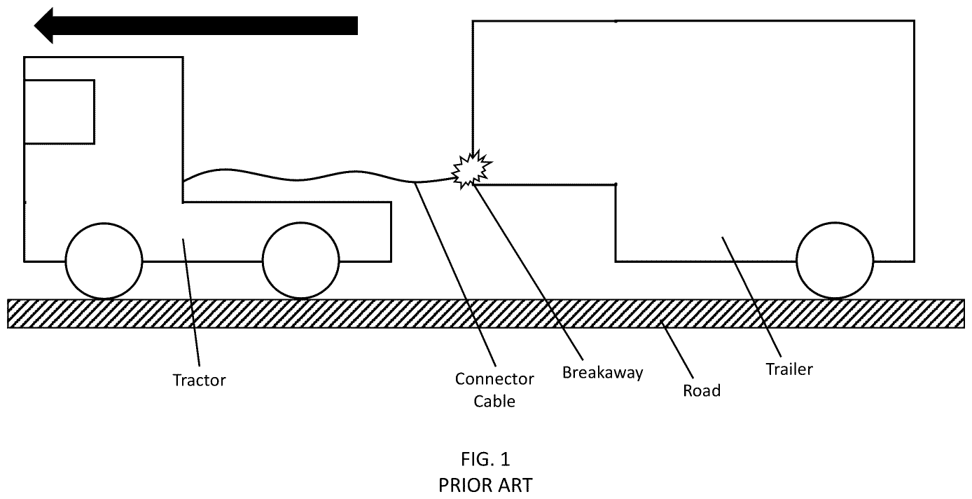

FIG. 2 illustrates an improperly stored connector plug dragging on the roadway in accordance with the prior art.

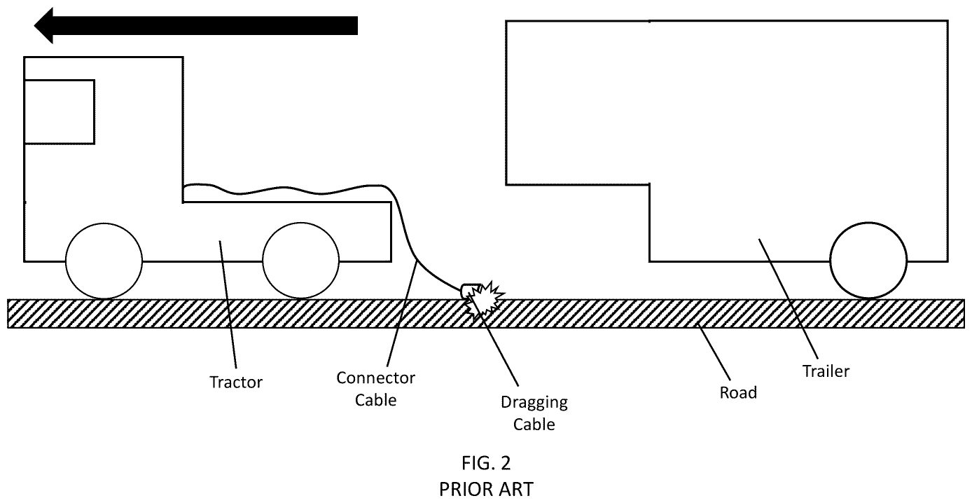

FIG. 3A illustrates a side view of an electrical park socket system in a hitched, connected operational state of a tractor and a trailer.

FIG. 3B illustrates a rear view of the tractor of the electrical park socket system of FIG. 3A.

FIG. 4A illustrates a side view of the electrical park socket system of FIG. 3A in an unhitched, disconnected operational state of the tractor and trailer.

FIG. 4B illustrates a rear view of the tractor of the electrical park socket system of FIG. 4A.

FIG. 5 illustrates a side view of the electrical park socket system of FIG. 4A in the unhitched, disconnected operational state, wherein the tractor has driven away from the disconnected trailer.

FIG. 6A illustrates a side view of a pneumatic park socket system in a hitched, connected operational state of a tractor and a trailer.

FIG. 6B illustrates a rear view of the tractor of the pneumatic park socket system of FIG. 6A.

FIG. 7A illustrates a side view of the pneumatic park socket system of FIG. 6A in an unhitched, disconnected operational state of the tractor and trailer.

FIG. 7B illustrates a rear view of the tractor of the pneumatic park socket system of FIG. 7A.

FIG. 8 illustrates a side view of the pneumatic park socket system of FIG. 7A in the unhitched, disconnected operational state, wherein the tractor has driven away from the disconnected trailer.

FIG. 9A illustrates a side view of an electrical and pneumatic park socket system in a hitched, connected operational state of a tractor and a trailer.

FIG. 9B illustrates a rear view of the tractor of the electrical and pneumatic park socket system of FIG. 9A.

FIG. 10A illustrates a side view of the electrical and pneumatic park socket system of FIG. 9A in an unhitched, disconnected operational state of the tractor and trailer.

FIG. 10B illustrates a rear view of the tractor of the electrical and pneumatic park socket system of FIG. 10A.

FIG. 11 illustrates a side view of the electrical and pneumatic park socket system of FIG. 10A in the unhitched, disconnected operational state, wherein the tractor has driven away from the disconnected trailer.

### DETAILED DESCRIPTION

Provided herein are park socket systems for drive-off prevention that provide a connector park socket on the tractor configured to receive and house a trailer-side plug of a connector cable and/or a trailer-side gladhand of a pneumatic line after disconnection from a trailer. The park socket system also includes a socket sensor to detect whether the plug and/or gladhand is present in the socket. Upon detection by the socket sensor that the plug and/or gladhand is absent from the park socket, an electronic control module of the park socket system can then restrict movement of the tractor.

### Connector Cable Park Sockets

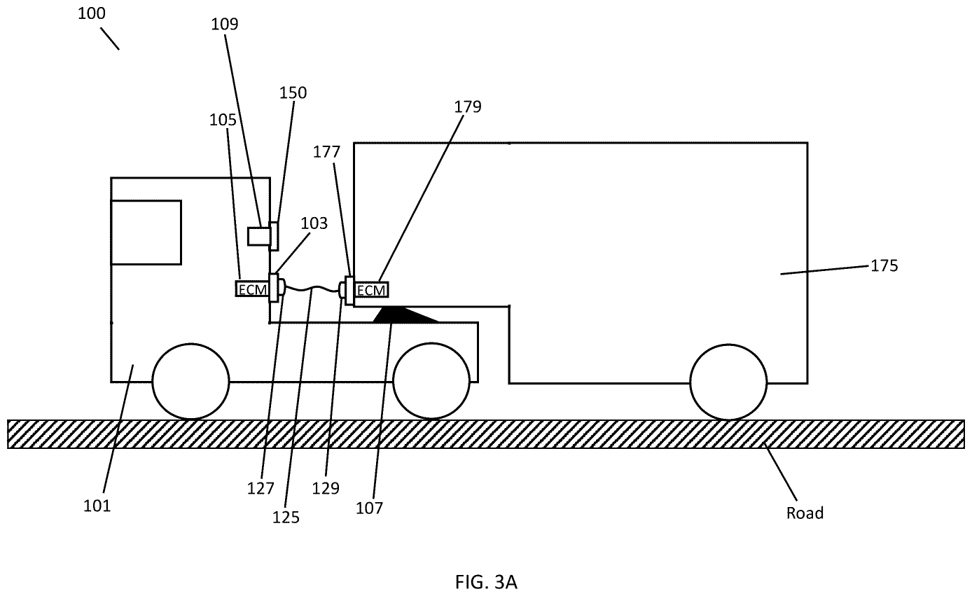

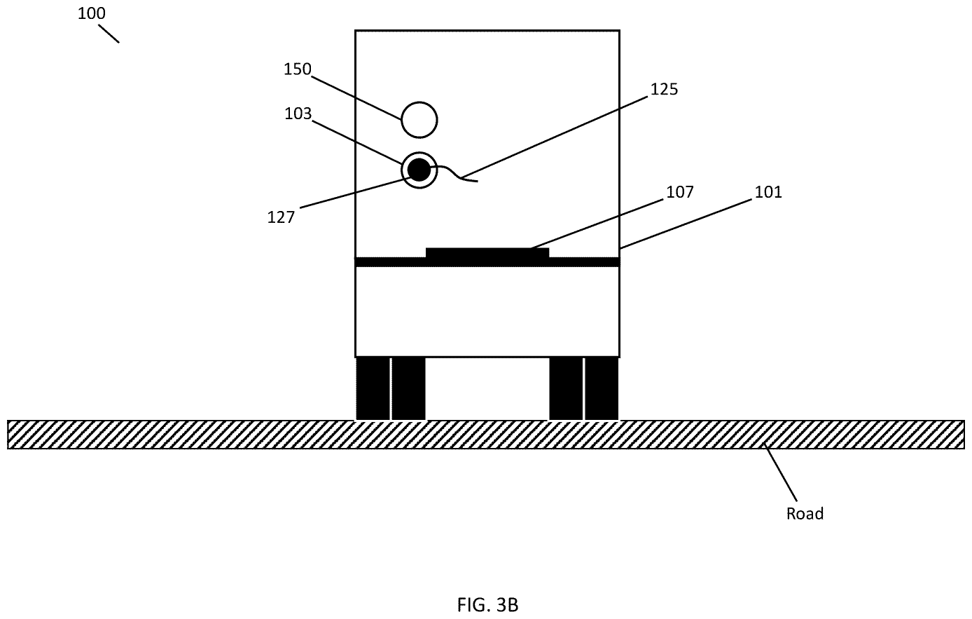

Referring now to FIGS. 3A-3B, 4A-4B, and 5, a park socket system for drive-off prevention 100 can include a tractor 101 having a hitch 107 (e.g., a fifth wheel as shown) for hitching the tractor to a trailer 175. The tractor 101 also includes a tractor-side socket 103 for receiving a tractor-side connector plug 127 of a connector cable 125. A park socket 150 of the tractor 101 generally remains unoccupied during ordinary, connected operation (e.g., as shown in FIGS. 3A-3B) while a trailer-side connector plug 129 of the connector cable 125 is plugged into a trailer-side socket 177 of the trailer 175.

The connector cable 125 can be any suitable cable, coiled or not, having any suitable type of tractor-and trailer-side connector plugs 127, 129 and corresponding tractor- and trailer-side sockets 103, 177 including, for example, single pole plugs and sockets, dual pole plugs and sockets, seven-way (e.g. SAE J560) plugs and sockets, thirteen-way plugs and sockets, fifteen-way plugs and sockets, seventeen-way plugs and sockets, or any other complementary plug and/or socket design.

In order to monitor status and functioning of the tractor 101 and/or the trailer 175, as well as providing various control functions with respect operation of the tractor 101 and/or the trailer 175, the tractor 101 can also include a tractor-side electronic control module 105 (“ECM” or “tractor controller”). The tractor-side ECM 105 can be configured for any number of functionalities including, for example, monitoring, tracking, and/or control over engine performance, emissions, transmission operation, braking systems, pneumatic systems and connections, electrical systems and connections, safety systems, lighting systems, connectivity between the tractor 101 and the trailer 175, trailer control signaling, driver clutch use, driver use of cruise control, driver braking habits, driver acceleration habits, speed, tire pressure, hitch status, any other aspect of the operation of the tractor 101 and/or trailer 175, or combinations thereof. Although shown herein as being positioned proximate or adjacent to the tractor-side socket 103, the tractor-side ECM 105 can generally be located anywhere in the tractor 101 including, for example, adjacent to the park socket 150 and/or anywhere in the cab.

In some embodiments, the trailer 175 can also include a corresponding trailer-side ECM 179 for providing two-way information exchange between the tractor 101 and the trailer 175, rather than limited one-sided monitoring and controlling by the tractor 101. In such embodiments, the trailer-side ECM 179 can monitor and report with respect to the operation of the trailer 175 including, for example, pneumatic systems and connections, electrical systems and connections, safety systems, lighting systems, braking systems, tire pressure, trailer weight, hitch status, landing gear, latch and/or lock status of trailer doors, interior temperature, any other aspect of the operation of the trailer 175, or combinations thereof. In addition, in some embodiments, the trailer-side ECM 179 can report on available trailer functionalities, receive operational control commands from the tractor-side ECM 105, and/or control the trailer 175 according to control commands received from the tractor-side ECM 105. Although shown herein as being positioned proximate or adjacent to the trailer-side socket 177, the trailer-side ECM 179 can generally be located in a nosebox of the trailer or at any other suitable location in the trailer 175.

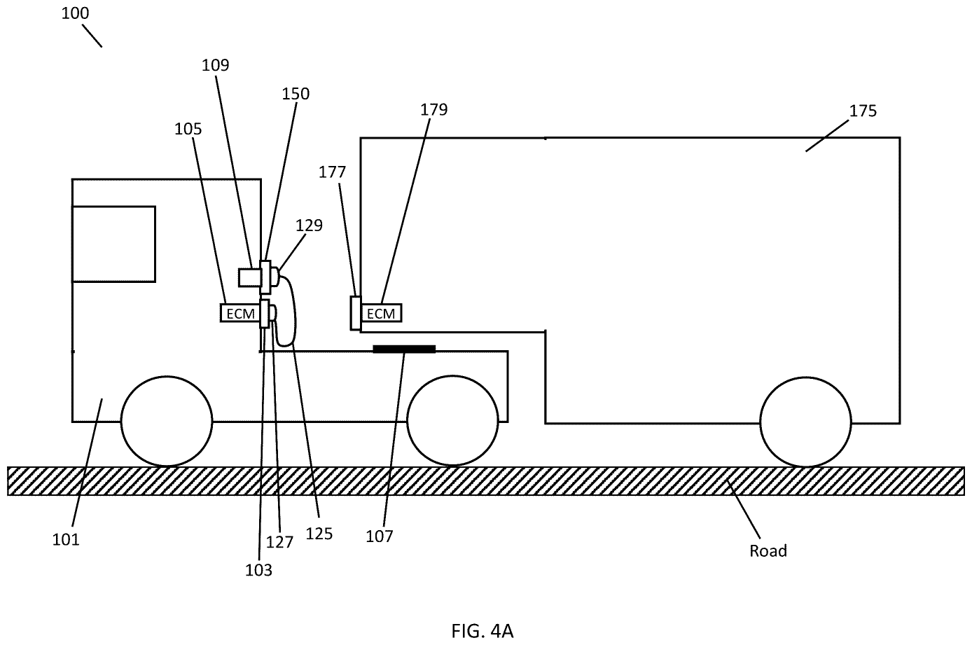

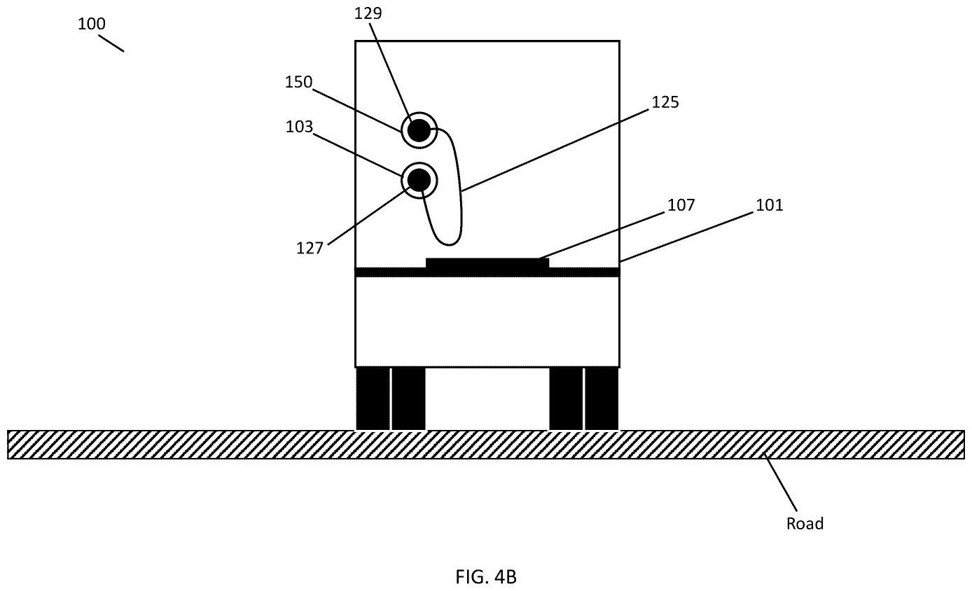

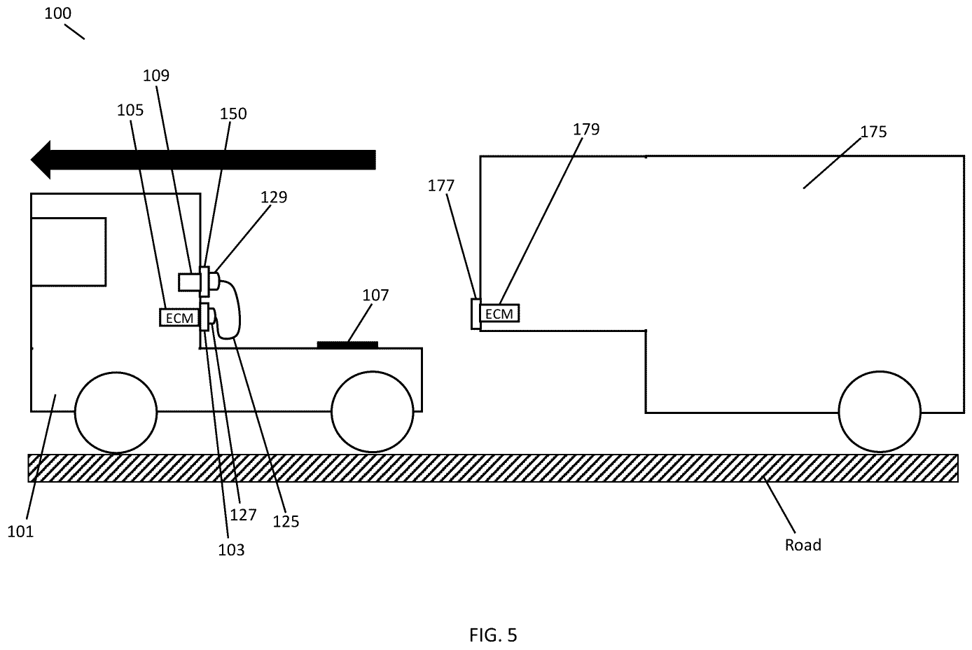

As shown in FIGS. 4A-4B and 5, during and after disconnection of the trailer 175 from the tractor 101, the park socket 150 is positioned on an exterior of the tractor 101 and configured to receive and house the disconnected trailer-side connector plug 129 of the connector cable 125. In this manner, the trailer side connector plug 129 is retained in place and protected from environmental elements such as such as water, salt, sand, dirt, grease, etc. by the park socket 150. Furthermore, such retention can aid in properly positioning the connector cable 125 itself to prevent unnecessary wear, tear, tangling, or abrasion thereof. In some embodiments the cable 125 can also be suspended on the tractor 101 by a tender kit (not shown).

Although shown and described herein as being positioned on a rear surface of a cab of the tractor 101 and being oriented in a rearward-facing direction relative to the tractor 101, the park socket 150, in accordance with various embodiments, can be positioned along any upper, lower, side, or rear surface of the tractor 101 and can be oriented in any upward-facing, downward-facing, side-facing, rear-facing, or angled direction relative to the tractor 101. Furthermore, although shown herein as protruding from the surface of the tractor 101, the park socket 150, in some embodiments can be configured to be flush with the surface of the tractor 101 on which it is positioned. In some embodiments, the park socket 150 can also be configured with a door or flap (not shown) to cover the park socket 150 when the trailer-side plug 129 is not positioned therein.

In some embodiments, the park socket 150 can be a complementary socket to the trailer-side connector plug 129, having a number of electrical contacts corresponding to or even exceeding a number of electrical contacts of the trailer-side connector plug 129. However, in order to reduce wear and tear on one or more pins of the trailer-side connector plug 129, the park socket 150 can alternatively be configured to have fewer electrical contacts than the trailer-side connector plug 129, or even no contacts at all, so long as such contacts are not required for detection of the trailer-side connector plug 129 in the park socket 150 by the socket sensor 109 as described in further detail below.

Although shown and described herein as an OEM-installed system original to the tractor 101, in some embodiments the park socket 150 can instead be installed as an aftermarket or retrofit assembly and/or kit. In such embodiments, the park socket 150 can generally be formed or positioned within a housing configured to be attached to/installed in the tractor 101. The housing can be attached/installed by any suitable means including, for example, mechanically fastening the housing to the tractor 101 (e.g., via bolts and/or nuts), chemically bonding the housing to the tractor 101 (e.g., via glue, epoxy, and/or other adhesives), welding the housing to the tractor 101, or combinations thereof.

In such embodiments, the socket sensor 109 and/or a communication module (discussed below) can advantageously be at least partially positioned within the housing so as to make a unitary package for ease of installation. Alternatively, in some embodiments the sensor 109 can be separated from the park socket 150 for flexibility in positioning between the sensor 109 and the park socket 150.

In use, the park socket 150 is configured to prevent drive-off of the tractor 101 away from the trailer 175 while the cable 125 is still connected to the trailer 175. This is achieved by the use of a socket sensor 109 for detecting a presence or absence of the trailer-side plug 129 within the park socket 150.

The socket sensor 109 can generally be any sensor or combination of sensors suitable for detecting a presence or absence of the trailer-side plug 129 in the park socket 150. Such sensors can include, for example, a resistive element, a series connected diode and resistor, an inductive sensor, a magnetic proximity sensor, a microswitch proximity detector, electrical connections between one or more pins of the park socket 150 and one or more electrical contacts of the trailer-side connector plug 129, any other suitable sensor, or combinations thereof. Several exemplary configurations are described in further detail below.

### Resistive Elements

In some embodiments, the socket sensor 109 can include one of a simple resistive element such as a resistor or a diode and resistor connected in series between any 2 or more electrical contacts in the park socket 150. In each case, such a configuration permits the tractor 101 to apply voltage to one contact and through the resistive element to detect continuity to another contact. Should such continuity be detected by the socket sensor 109, the ECM 105 is able to determine that the trailer-side plug 129 is present in the park socket 150, indicating that the connector cable 125 is properly disconnected and stored and the tractor 101 is ready to drive off safely.

On the other hand, should the socket sensor 109 fail to detect continuity, the ECM 105 is able to determine that the trailer-side plug 129 is not present in the park socket 150, indicating that the connector cable 125 has not been properly disconnected and stored. Upon such detection, the ECM 105 can then operate to restrict movement of the tractor 101 as described in greater detail below.

In embodiments having the series resistor and diode, false positives can advantageously be prevented because such a socket sensor 109 circuit prevents a short circuit from being read as continuity across the two or more contacts by the tractor 101 when checking for continuity with polarity reversed on the pins. In some embodiments, in addition to continuity, the resistance can also be measured across the two or more contacts to verify that the cable 125 is not shorted on those particular contacts.

The use of such a simple, resistive element-based configuration advantageously has a very low cost of implementation, essentially only requiring mounting of the park socket 150 somewhere on the tractor 101. However, the simplified nature of such a configuration does create the possibility of accidentally measuring continuity or a resistance value when the cable 125 is still connected to the trailer 175 if the characteristics of the trailer 175 match detection parameters. For this reason, it is important to carefully consider which pins are used for such a configuration. Addition of the diode potentially alleviates this error source as discussed above.

Another consideration associated with the use of a contact-based configuration such as the resistive element and/or resistive element with diode is that the trailer-side plug 129 must be physically plugged into pins of the park socket 150, thereby doubling the in-field cycle count for the contacts being used by the park socket 150 and thus reducing service life of the cable 125. The addition of contacts to the trailer-side plug 129 that are located differently from the normal contacts used (e.g., end contacts instead of the contacts inside the contact cylinder, using smaller pins, using brass brush contacts, or other lighter contact pressure methods) may at least partially mitigate this issue and the use of a brass brush contact may facilitate a cleaning action that is also beneficial to the primary contacts. However, requiring the use of a modified trailer-side plug 129 including such additional contacts adds cost and limits backward compatibility of the park socket system 100.

### Tractor Based Continuity

In some embodiments, the socket sensor 109 can include two specific pins in the park socket 150 electrically connected within the cab of the tractor 101. This configuration permits the tractor 101 to do a continuity test on specific circuits in the cable 125 to determine the presence or absence of the trailer-side plug 129. This is different from the resistive element configuration in that the pins are not connected together in the park socket 150, but are instead electrically connected inside the tractor 101, thus allowing the tractor 101 to perform a continuity check on a single pin/contact. Although such an embodiment requires a more complex and expensive electrical connection back to the cab, this configuration offers a more robust method to identify whether or not the trailer-side plug 129 is in the park socket 150. However, as described above in connection with the resistive element configuration, the trailer-side plug 129 must be physically plugged into pins of the park socket 150, thereby doubling the in-field cycle count for the contacts being used by the park socket 150 and thus reducing service life of the cable 125 unless a lower impact contact method is used.

### Inductive Proximity Sensor

In some embodiments, the socket sensor 109 can be an inductive sensor located in the park socket 150 to detect a proximity of the trailer-side plug 129. Such inductive sensors are effective for detecting the trailer-side plug 129 because the contacts trailer-side plug 129 are made of brass and can therefore be detected by inductive sensors. In such configurations, the park socket 150 would need an electrical connection to the interior of the cab in order to power the inductive sensor. Due to component and wiring costs, such inductive sensor configurations have a higher cost of implementation. However, such inductive sensor configurations advantageously avoid the risk of false detections associated with short circuits and, because the inductive sensors are non-contact, the park socket 150 does not require a physical connection to the electrical contacts of the trailer-side plug 129. Thus, such inductive sensor configurations also have the benefit of not increasing the in-field cycle count of the contacts of the trailer-side plug 129, preserving service life of the cable 125.

### Magnetic Proximity Sensor

In some embodiments, the socket sensor 109 can be a magnetic sensor located in the park socket 150 to detect a proximity of the trailer-side plug 129. The magnetic proximity sensor determines the presence or absence of the trailer-side plug 129 by emitting a magnetic field and detecting changes in the magnetic moment of magnetic material in the detected object. However, because the brass contacts of the trailer-side plug 129 are not ferromagnetic, the trailer-side plug 129 would require modification to include a magnet or ferromagnetic material therein, thereby requiring customization of the cable 125 and limiting backward compatibility of the park socket system 100. As with the inductive sensor configuration above, an electrical connection into the cab of the tractor 101 is necessary to power the magnetic proximity sensor.

Advantageously, because magnetic proximity sensors are significantly less expensive than inductive proximity sensors, such a magnetic proximity sensor configuration is less expensive to implement. Also, similar to the inductive sensor configuration, such magnetic proximity sensor configurations advantageously avoid the risk of false detections due to short circuits and, because the magnetic proximity sensors are non-contact, the park socket 150 does not require a physical connection to the electrical contacts of the trailer-side plug 129. Thus, such magnetic proximity sensor configurations also have the benefit of not increasing the in-field cycle count of the contacts of the trailer-side plug 129, preserving service life of the cable 125.

### Microswitch Proximity Detector

In some embodiments, the socket sensor 109 can be a microswitch proximity detector (also referred to as “mechanical proximity switches” or “limit switches”) in the park socket 150 that is actuated when the trailer-side plug 129 is inserted. Such microswitch proximity detectors determine the presence or absence of the trailer-side plug 129 by being positioned such that a mechanical arm attached to a switch is pressed or otherwise actuated by insertion of the trailer-side plug 129 into the park socket 150. As with the inductive sensor configuration above, an electrical connection into the cab of the tractor 101 is necessary to operate the microswitch proximity detector.

Advantageously, microswitch proximity detectors are significantly less expensive than inductive proximity sensors or magnetic proximity sensors, such microswitch configurations is less expensive to implement. Also, similar to the inductive sensor configuration, such microswitch proximity detector configurations advantageously avoid the risk of false detections due to short circuits. Furthermore, because the microswitch proximity detectors are actuated by the mechanical force of the exterior of the trailer-side plug 129, the park socket 150 does not require a physical connection to the electrical contacts of the trailer-side plug 129. Thus, such microswitch proximity detector configurations also have the benefit of not increasing the in-field cycle count of the contacts of the trailer-side plug 129, preserving service life of the cable 125.

Although several exemplary socket sensor 109 configurations have been described above, it will be apparent in view of this disclosure that any other configuration wherein a socket sensor 109 is capable of detecting a presence or absence of the trailer-side plug 129 in the park socket 150 can be used in accordance with various embodiments.

In use, the socket sensor 109 can be configured to provide real-time sensor data to the tractor-side ECM 105 such that the tractor-side ECM 105 can diagnose the absence or presence of the trailer-side plug 129 in the park socket 150 and, in the event of an absence of the trailer-side plug 129 from the park socket 150, the ECM 105 can restrict movement of the tractor 101. Restriction of movement of the tractor 101 can be achieved, for example, by one or more of preventing a gear change of the tractor, engaging a brake of the tractor, preventing an engine ignition of the tractor, prompting a driver of the tractor 101 to provide driver feedback confirming disconnection of the trailer-side plug 129 from the trailer 175, prompting a driver of the tractor 101 to provide driver feedback confirming secure disconnected storage of the trailer-side plug 129 on the tractor 101, or combinations thereof.

Where applicable, driver prompts can be presented and responded to, for example, via one or more electronic interface (e.g., touch screens, heads up displays, or other such displays or controls) within the cab of the tractor 101 or proximate the park socket 150. Alternatively, such prompts can be presented and responded to via one or more driver mobile devices (e.g., a laptop, tablet, or smartphone).

In some embodiments, socket sensor 109 can electronically communicate with the tractor controller (ECM 105) in order to provide sensor data such that the ECM 105 can determine the absence or presence of the trailer-side connector plug 129 in the park socket 150 and, if necessary, restrict movement of the tractor 101. Alternatively, the socket sensor 109 can be configured to determine the absence or presence and instruct the ECM 105, if necessary, to restrict movement of the tractor 101. In such embodiments, the socket sensor 109 can be, for example, one or more of directly wired to the tractor controller, connected to the tractor controller via a wired network connection (e.g., a controller area network (CAN) or ethernet), connected to the tractor controller via a wireless connection (e.g., Bluetooth, Wi-Fi, near-field communication (NFC), or cellular signal such as 3G, 4G, 5G, or 6G), or combinations thereof.

In some embodiments, the park socket 150 can include a communications module (not shown) configured to communicate with the ECM 105. In such embodiments, the communications module can similarly provide sensor data such that the ECM 105 can determine the absence or presence of the trailer-side connector plug 129 in the park socket 150 and, if necessary, restrict movement of the tractor 101. In addition, the socket sensor 109 and/or communications module can be configured to determine the absence or presence and instruct the ECM 105, if necessary, to restrict movement of the tractor 101. In such embodiments, the communications module can be configured to receive sensor data and/or instructions from the socket sensor 109 and can be, for example, one or more of directly wired to the tractor controller, connected to the tractor controller via a wired network connection (e.g., a controller area network (CAN) or ethernet), connected to the tractor controller via a wireless connection (e.g., Bluetooth, Wi-Fi, near-field communication (NFC), or cellular signal such as 3G, 4G, 5G, or 6G), or combinations thereof.

### Pneumatic Park Sockets

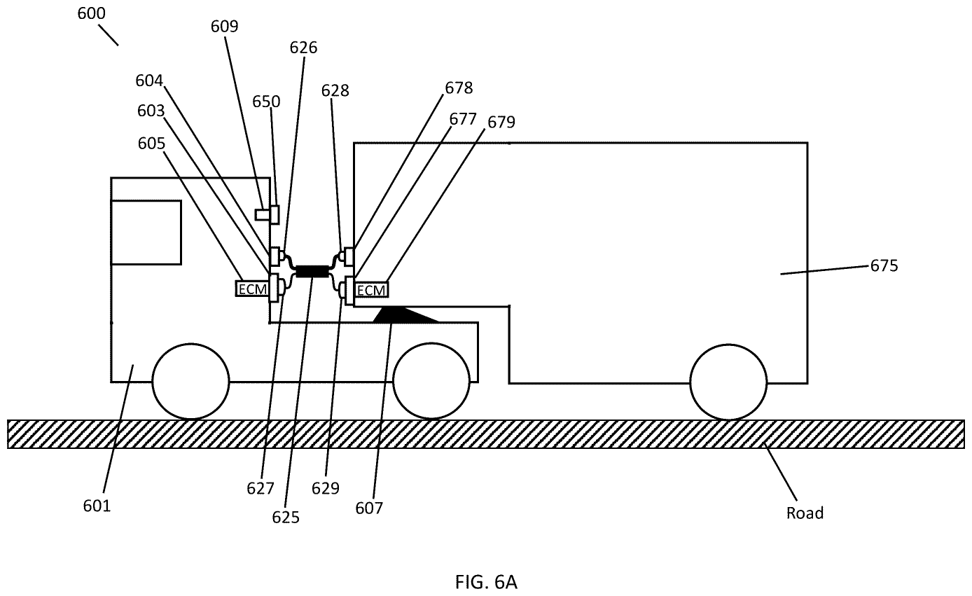

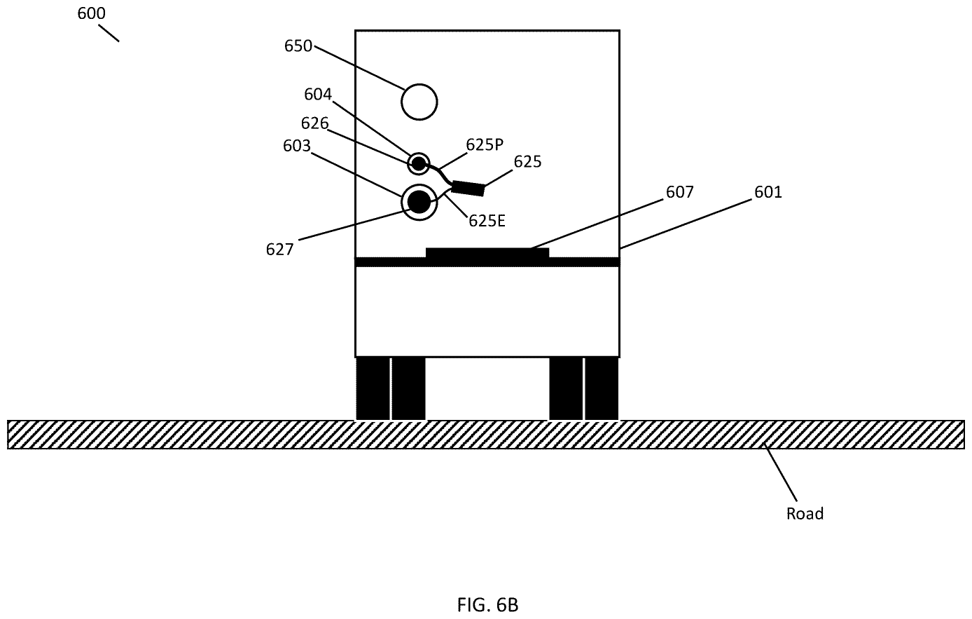

Referring now to FIGS. 6A-6B, 7A-7B, and 8, a park socket system for drive-off prevention 600 can include a tractor 601 having a hitch 607 (e.g., a fifth wheel as shown) for hitching the tractor to a trailer 675. The tractor 601 also includes a tractor-side electrical socket 603 for receiving a tractor-side connector plug 627 of a connector cable 625E of an airpower line 625 and a tractor-side pneumatic coupling 604 for receiving a tractor-side pneumatic coupling 626 (e.g., a gladhand) of a pneumatic line 625P of the airpower line 625. A park socket 650 of the tractor 601 generally remains unoccupied during ordinary, connected operation (e.g., as shown in FIGS. 6A-6B) while a trailer-side pneumatic coupling 628 (e.g., a gladhand) of the pneumatic line 625P is connected to a trailer-side pneumatic coupling 678 of the trailer 675 and a trailer-side connector plug 629 of the connector cable 625E is plugged into a trailer-side electrical socket 677.

As shown in FIGS. 6A-6B, 7A-7B, and 8, in some embodiments the park socket 650 can be configured for receiving the trailer-side pneumatic coupling 678 of the pneumatic line 625P of the airpower line 625. However, although described and shown herein as being used with an airpower line, it will be apparent in view of this disclosure that such pneumatic-receiving park sockets can be used in connection with any pneumatic coupling of any pneumatic line, whether a single pneumatic line, a pneumatic line pair, or one or more pneumatic lines incorporated into an airpower line.

Referring again to FIGS. 6A-6B, 7A-7B, and 8, the airpower line 625 can include any suitable cable, wherein the connector cable 625E can include any suitable type of tractor- and trailer-side connector plugs 627, 629 and corresponding tractor-and trailer-side sockets 603, 677 including, for example, single pole plugs and sockets, dual pole plugs and sockets, seven-way (e.g. SAE J560) plugs and sockets, thirteen-way plugs and sockets, fifteen-way plugs and sockets, seventeen-way plugs and sockets, or any other complementary plug and/or socket design.

Similarly, the airpower line 625 can include any suitable pneumatic line 625P having any type or style of tractor-and trailer-side pneumatic couplings 626, 628 such as gladhands or any other pneumatic line coupling capable of being coupled to the tractor-and trailer-side pneumatic couplings 604, 678.

In order to monitor status and functioning of the tractor 601 and/or the trailer 675, as well as providing various control functions with respect operation of the tractor 601 and/or the trailer 675, the tractor 601 can also include a tractor-side electronic control module 605 (“ECM” or “tractor controller”). The tractor-side ECM 605 can be configured for any number of functionalities including, for example, monitoring, tracking, and/or control over engine performance, emissions, transmission operation, braking systems, pneumatic systems and connections, electrical systems and connections, safety systems, lighting systems, connectivity between the tractor 601 and the trailer 675, trailer control signaling, driver clutch use, driver use of cruise control, driver braking habits, driver acceleration habits, speed, tire pressure, hitch status, any other aspect of the operation of the tractor 601 and/or trailer 675, or combinations thereof. Although shown herein as being positioned proximate or adjacent to the tractor-side socket 603, the tractor-side ECM 605 can generally be located anywhere in the tractor 601 including, for example, adjacent to the park socket 650 and/or anywhere in the cab.

In some embodiments, the trailer 675 can also include a corresponding trailer-side ECM 679 for providing two-way information exchange between the tractor 601 and the trailer 675, rather than limited one-sided monitoring and controlling by the tractor 601. In such embodiments, the trailer-side ECM 679 can monitor and report with respect to the operation of the trailer 675 including, for example, pneumatic systems and connections, electrical systems and connections, safety systems, lighting systems, braking systems, tire pressure, trailer weight, hitch status, landing gear, latch and/or lock status of trailer doors, interior temperature, any other aspect of the operation of the trailer 675, or combinations thereof. In addition, in some embodiments, the trailer-side ECM 679 can report on available trailer functionalities, receive operational control commands from the tractor-side ECM 605, and/or control the trailer 675 according to control commands received from the tractor-side ECM 605. Although shown herein as being positioned proximate or adjacent to the trailer-side socket 677, the trailer-side ECM 679 can generally be located in a nosebox of the trailer or at any other suitable location in the trailer 675.

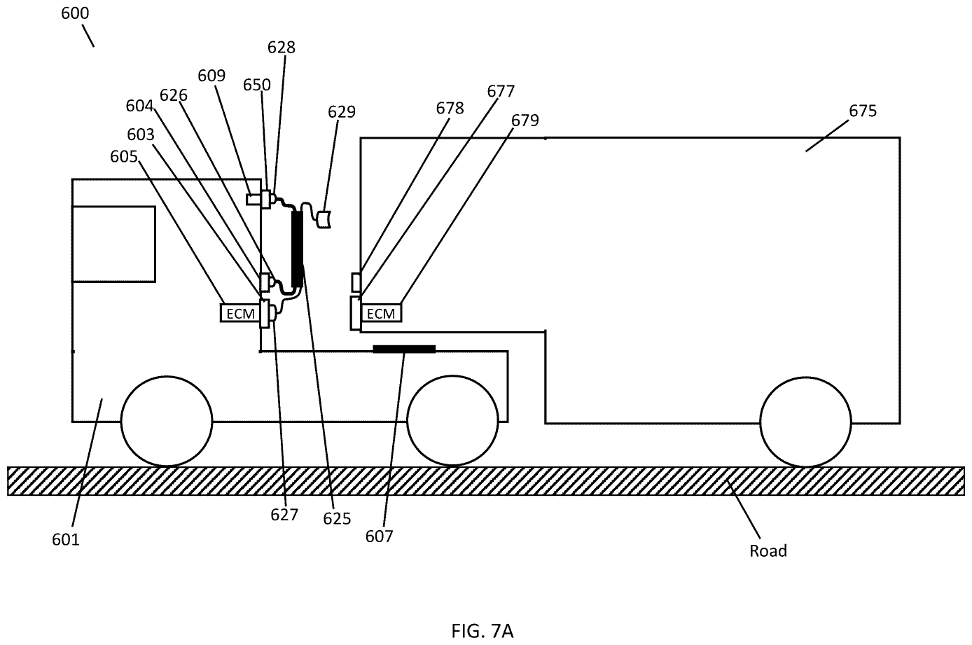

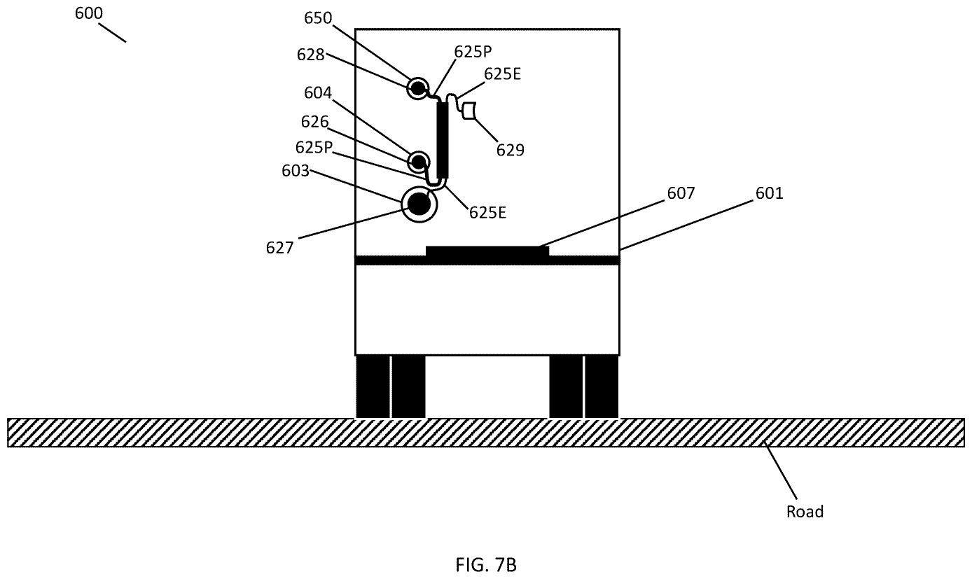

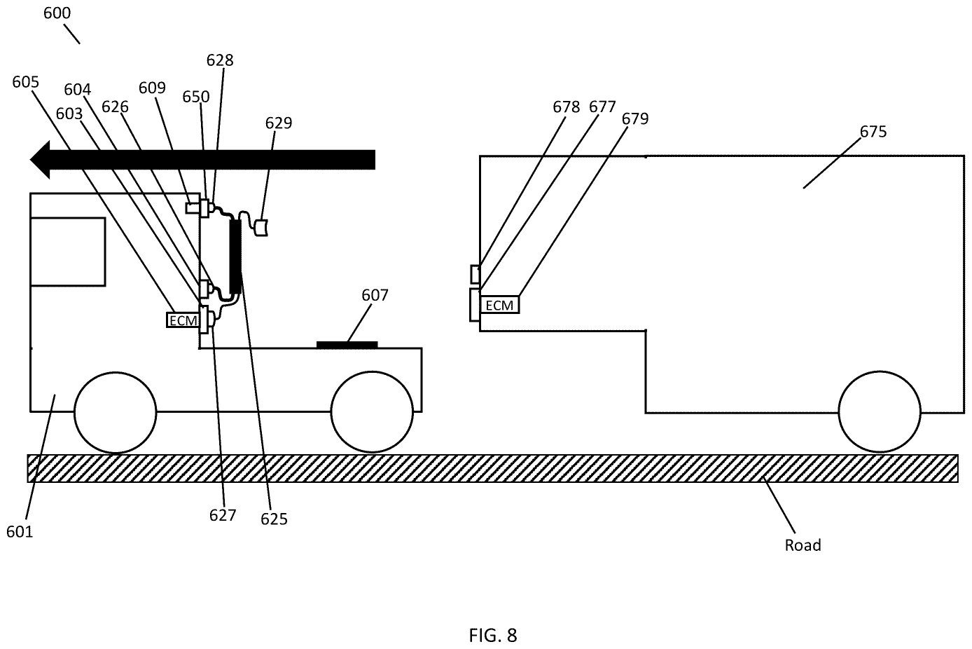

As shown in FIGS. 7A-7B and 8, during and after disconnection of the trailer 675 from the tractor 601, the park socket 650 is positioned on an exterior of the tractor 601 and configured to receive and house the disconnected trailer-side pneumatic coupling 628 of the pneumatic line 625P. In this manner, the trailer-side pneumatic coupling 628 is retained in place and protected from environmental elements such as water, salt, sand, dirt, grease, etc. by the park socket 650. Furthermore, such retention can aid in properly positioning the pneumatic line 625P itself as well as, in some embodiments, the airpower line 625 and connector cable 625E (e.g., as shown) to prevent unnecessary wear, tear, tangling, or abrasion thereof. In some embodiments the airpower line 625 can also be suspended on the tractor 601 by a tender kit (not shown).

Although shown and described herein as being positioned on a rear surface of a cab of the tractor 601 and being oriented in a rearward-facing direction relative to the tractor 601, the park socket 650, in accordance with various embodiments, can be positioned along any upper, lower, side, or rear surface of the tractor 601 and can be oriented in any upward-facing, downward-facing, side-facing, rear-facing, or angled direction relative to the tractor 601. Furthermore, although shown herein as protruding from the surface of the tractor 601, the park socket 650, in some embodiments can be configured to be flush with the surface of the tractor 601 on which it is positioned. In some embodiments, the park socket 650 can also be configured with a door or flap (not shown) to cover the park socket 650 when the trailer-side pneumatic coupling 628 is not positioned therein.

In some embodiments, the park socket 650 can be a complementary pneumatic coupling to the trailer-side pneumatic coupling 628, such as, for example, having a corresponding gladhand. However, in order to reduce wear and tear on the trailer-side pneumatic coupling 628, the park socket 650 can alternatively be configured to merely retain and house the trailer-side pneumatic coupling 628 without coupling thereto, so long as such coupling is not required for detection of the trailer-side pneumatic coupling 628 in the park socket 650 by the socket sensor 609 as described in further detail below.

Although shown and described herein as an OEM-installed system original to the tractor 601, in some embodiments the park socket 650 can instead be installed as an aftermarket or retrofit assembly and/or kit. In such embodiments, the park socket 650 can generally be formed or positioned within a housing configured to be attached to/installed in the tractor 601. The housing can be attached/installed by any suitable means including, for example, mechanically fastening the housing to the tractor 601 (e.g., via bolts and/or nuts), chemically bonding the housing to the tractor 601 (e.g., via glue, epoxy, and/or other adhesives), welding the housing to the tractor 601, or combinations thereof.

In such embodiments, the socket sensor 609 and/or a communication module (discussed below) can advantageously be at least partially positioned within the housing so as to make a unitary package for ease of installation. Alternatively, in some embodiments the sensor 609 can be separated from the park socket 650 for flexibility in positioning between the sensor 609 and the park socket 650.

In use, the park socket 650 is configured to prevent drive-off of the tractor 601 away from the trailer 675 while the pneumatic line 625P and/or the airpower line 625 more generally are still connected to the trailer 675. This is achieved by the use of a socket sensor 609 for detecting a presence or absence of the trailer-side pneumatic coupling 628 within the park socket 650.

The socket sensor 609 can generally be any sensor or combination of sensors suitable for detecting a presence or absence of the trailer-side pneumatic coupling 628 in the park socket 650. Such sensors can include, for example, a resistive element, a series connected diode and resistor, an inductive sensor, a magnetic proximity sensor, a microswitch proximity detector, any other suitable sensor, or combinations thereof. Several exemplary configurations are described in further detail above with reference to FIGS. 3A-3B, 4A-4B, and 5. In particular, the configurations described above using inductive proximity sensors, magnetic proximity sensors, and microswitch proximity sensors would also be suitable for detection of the trailer-side pneumatic coupling 628. In addition, to the extent that the park socket 650 includes a complementary pneumatic coupling to the trailer-side pneumatic coupling 628 and the trailer-side pneumatic coupling 628 is coupled to the park socket 650, a continuity sensing configuration can also be used, although such a configuration may result in premature corrosion of the trailer-side pneumatic coupling 628.

### Electrical and Pneumatic Park Sockets

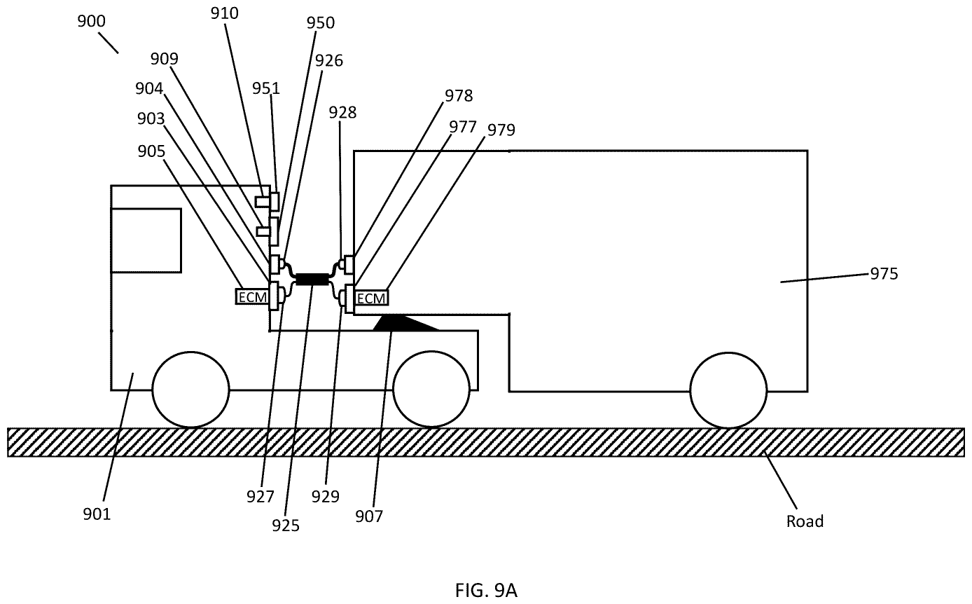

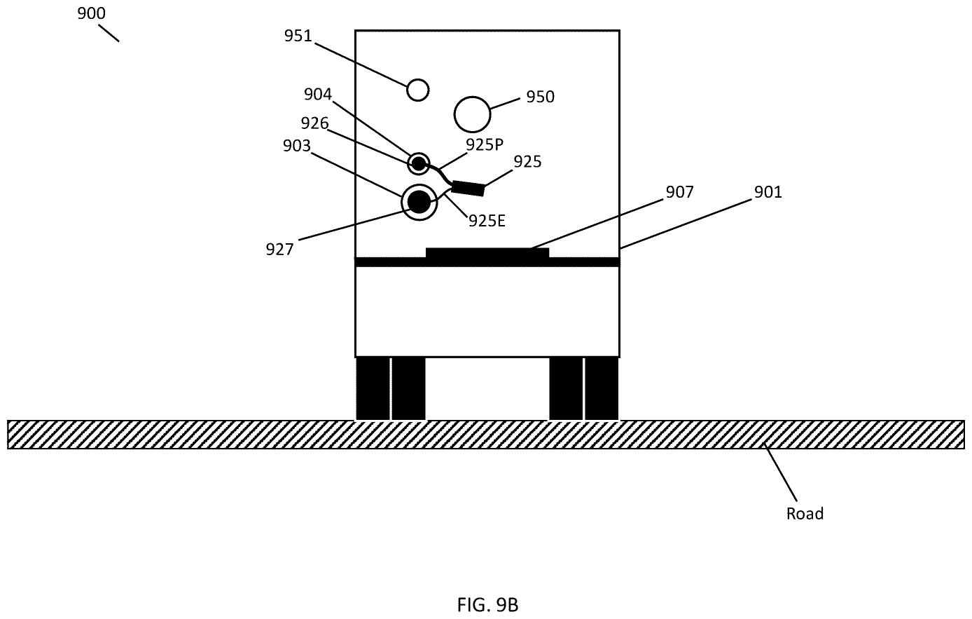

Referring now to FIGS. 9A-9B, 10A-10B, and 11, a park socket system for drive-off prevention 900 can include a tractor 901 having a hitch 907 (e.g., a fifth wheel as shown) for hitching the tractor to a trailer 975. The tractor 901 also includes a tractor-side electrical socket 903 for receiving a tractor-side connector plug 927 of a connector cable 925E of an airpower line 925 and a tractor-side pneumatic coupling 904 for receiving a tractor-side pneumatic coupling 926 (e.g., a gladhand) of a pneumatic line 925P of the airpower line 925. Both an electrical park socket 950 and a pneumatic park socket 651 of the tractor 901 generally remain unoccupied during ordinary, connected operation (e.g., as shown in FIGS. 9A-9B) while a trailer-side pneumatic coupling 928 (e.g., a gladhand) of the pneumatic line 925P is connected to a trailer-side pneumatic coupling 978 of the trailer 975 and a trailer-side connector plug 929 of the connector cable 925E is plugged into a trailer-side electrical socket 977.

As shown in FIGS. 9A-9B, 10A-10B, and 11, in some embodiments the pneumatic park socket 951 can be configured for receiving the trailer-side pneumatic coupling 928 of the pneumatic line 925P of the airpower line 925 and the electrical park socket 950 can be configured for receiving the trailer-side connector plug 929 of the connector cable 925E of the airpower line 925. However, although described and shown herein as being used with an airpower line, it will be apparent in view of this disclosure that such pneumatic and electrical park sockets can be used in connection with any combination of connector cables and pneumatic lines. For example, the pneumatic park socket 651 can be used with any pneumatic coupling of any pneumatic line, whether a single pneumatic line, a standalone pneumatic line pair, or one or more pneumatic lines incorporated into an airpower line. Similarly, the electrical park socket can be used with any connector plug of any connector cable, whether a single cable, a standalone cable bundle, or one or more connector cables incorporated into an airpower line.

Referring again to FIGS. 9A-9B, 10A-10B, and 11, the airpower line 925 can include any suitable cable, wherein the connector cable 925E can include any suitable type of tractor- and trailer-side connector plugs 927, 929 and corresponding tractor- and trailer-side sockets 903, 977 including, for example, single pole plugs and sockets, dual pole plugs and sockets, seven-way (e.g. SAE J560) plugs and sockets, thirteen-way plugs and sockets, fifteen-way plugs and sockets, seventeen-way plugs and sockets, or any other complementary plug and/or socket design.

Similarly, the airpower line 925 can include any suitable pneumatic line 925P having any type or style of tractor-and trailer-side pneumatic couplings 926, 928 such as gladhands or any other pneumatic line coupling capable of being coupled to the tractor-and trailer-side pneumatic couplings 904, 978.

In order to monitor status and functioning of the tractor 901 and/or the trailer 975, as well as providing various control functions with respect operation of the tractor 901 and/or the trailer 975, the tractor 901 can also include a tractor-side electronic control module 905 (“ECM” or “tractor controller”). The tractor-side ECM 905 can be configured for any number of functionalities including, for example, monitoring, tracking, and/or control over engine performance, emissions, transmission operation, braking systems, pneumatic systems and connections, electrical systems and connections, safety systems, lighting systems, connectivity between the tractor 901 and the trailer 975, trailer control signaling, driver clutch use, driver use of cruise control, driver braking habits, driver acceleration habits, speed, tire pressure, hitch status, any other aspect of the operation of the tractor 901 and/or trailer 975, or combinations thereof. Although shown herein as being positioned proximate or adjacent to the tractor-side socket 903, the tractor-side ECM 905 can generally be located anywhere in the tractor 901 including, for example, adjacent to the park socket 950 and/or anywhere in the cab.

In some embodiments, the trailer 975 can also include a corresponding trailer-side ECM 979 for providing two-way information exchange between the tractor 901 and the trailer 975, rather than limited one-sided monitoring and controlling by the tractor 901. In such embodiments, the trailer-side ECM 979 can monitor and report with respect to the operation of the trailer 975 including, for example, pneumatic systems and connections, electrical systems and connections, safety systems, lighting systems, braking systems, tire pressure, trailer weight, hitch status, landing gear, latch and/or lock status of trailer doors, interior temperature, any other aspect of the operation of the trailer 975, or combinations thereof. In addition, in some embodiments, the trailer-side ECM 979 can report on available trailer functionalities, receive operational control commands from the tractor-side ECM 905, and/or control the trailer 975 according to control commands received from the tractor-side ECM 905. Although shown herein as being positioned proximate or adjacent to the trailer-side socket 977, the trailer-side ECM 979 can generally be located in a nosebox of the trailer or at any other suitable location in the trailer 975.

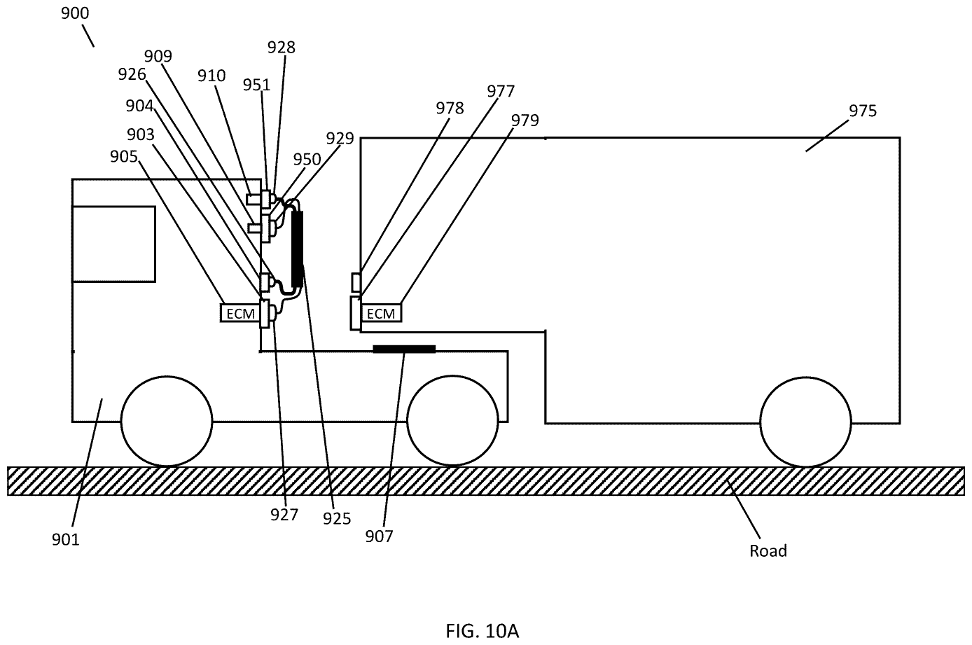

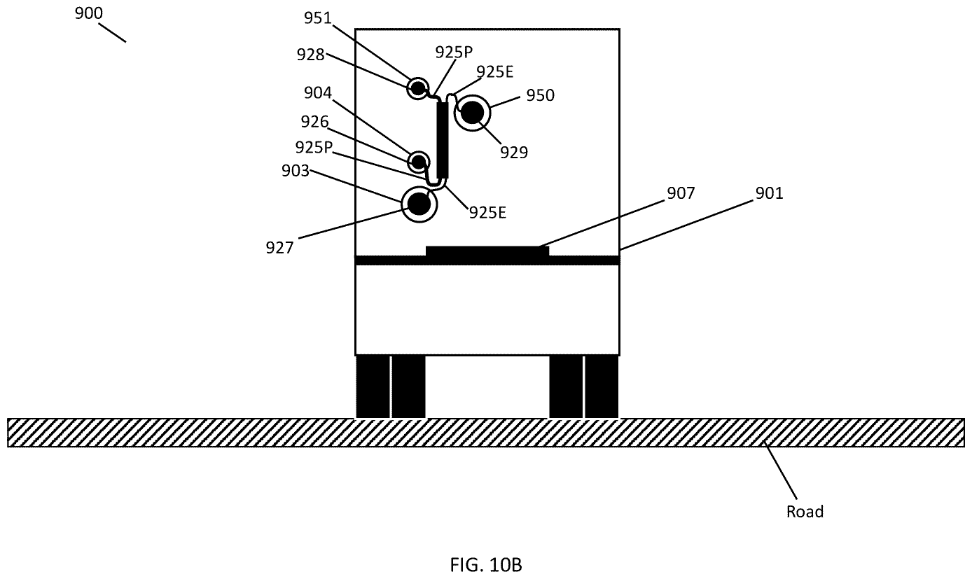

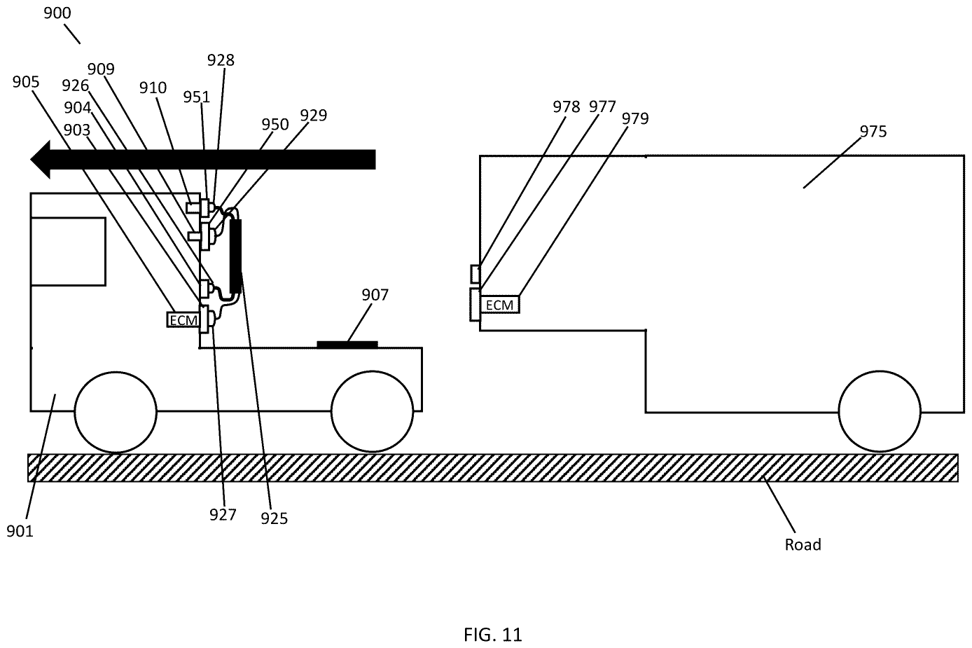

As shown in FIGS. 10A-10B and 11, during and after disconnection of the trailer 975 from the tractor 901, the pneumatic park socket 951 is positioned on an exterior of the tractor 901 and configured to receive and house the disconnected trailer-side pneumatic coupling 928 of the pneumatic line 925P and the electrical park socket 950 is similarly positioned on an exterior of the tractor 901 and configured to receive and house the disconnected trailer-side connector plug 929 of the connector cable 925E. In this manner, the trailer-side pneumatic coupling 928 and trailer-side connector plug 929 retained in place and protected from environmental elements such as water, salt, sand, dirt, grease, etc. by the respective park socket 951, 950. Furthermore, as shown, such retention can aid in properly positioning the pneumatic line 925P, the connector cable 925E, and/or the airpower line 925 more generally to prevent unnecessary wear, tear, tangling, or abrasion thereof. In some embodiments the pneumatic line 925P, the connector cable 925E, and/or the airpower line 925 can also be suspended on the tractor 901 by a tender kit (not shown).

Although shown and described herein as being positioned on a rear surface of a cab of the tractor 901 and being oriented in a rearward-facing direction relative to the tractor 901, the electrical and pneumatic park sockets 950, 951, in accordance with various embodiments, can be positioned along any upper, lower, side, or rear surface of the tractor 901 and can be oriented in any upward-facing, downward-facing, side-facing, rear-facing, or angled direction relative to the tractor 901. Furthermore, although shown herein as protruding from the surface of the tractor 901, the electrical and pneumatic park sockets 950, 951, in some embodiments can be configured to be flush with the surface of the tractor 901 on which it is positioned. In some embodiments, the park socket 950 can also be configured with a door or flap (not shown) to cover the park socket 950 when the trailer-side pneumatic coupling 928 is not positioned therein. Furthermore, although shown and described herein as being two separate park sockets, in some embodiments, the electrical and pneumatic park sockets 950, 951 can instead be combined within a single larger park socket or housing for convenience.

In some embodiments, the pneumatic park socket 951 can be a complementary pneumatic coupling to the trailer-side pneumatic coupling 928, such as, for example, having a corresponding gladhand. However, in order to reduce wear and tear on the trailer-side pneumatic coupling 928, the park socket 950 can alternatively be configured to merely retain and house the trailer-side pneumatic coupling 928 without coupling thereto, so long as such coupling is not required for detection of the trailer-side pneumatic coupling 928 in the pneumatic park socket 951 by the pneumatic socket sensor 910 as described in further detail below.

In some embodiments, the electrical park socket 950 can be a complementary socket to the trailer-side connector plug 929, having a number of electrical contacts corresponding to or even exceeding a number of electrical contacts of the trailer-side connector plug 929. However, in order to reduce wear and tear on one or more pins of the trailer-side connector plug 929, the electrical park socket 950 can alternatively be configured to have fewer electrical contacts than the trailer-side connector plug 929, or even no contacts at all, so long as such contacts are not required for detection of the trailer-side connector plug 929 in the electrical park socket 950 by the electrical socket sensor 909 as described in further detail below.

Although shown and described herein as OEM-installed systems original to the tractor 901, in some embodiments the electrical and pneumatic park sockets 950, 951 can each instead be installed as an aftermarket or retrofit assembly and/or kit. In such embodiments, the electrical and pneumatic park sockets 950, 951 can each generally be formed or positioned within a housing configured to be attached to/installed in the tractor 901. The housing can be attached/installed by any suitable means including, for example, mechanically fastening the housing to the tractor 901 (e.g., via bolts and/or nuts), chemically bonding the housing to the tractor 901 (e.g., via glue, epoxy, and/or other adhesives), welding the housing to the tractor 901, or combinations thereof.

In such embodiments, the respective electrical or pneumatic socket sensor 909, 910 and/or a communication module (discussed above) can advantageously be at least partially positioned within the housing so as to make a unitary package for ease of installation. Alternatively, in some embodiments the electrical or pneumatic socket sensor 909, 910 can be separated from the respective electrical or pneumatic park socket 950, 951 for flexibility in positioning between the electrical or pneumatic socket sensor 909, 910 and the respective electrical or pneumatic park socket 950, 951.

In use, the electrical and pneumatic park sockets 950, 951 are configured to prevent drive-off of the tractor 901 away from the trailer 975 while the pneumatic line 925P, the connector cable 925E, and/or the airpower line 925 more generally are still connected to the trailer 975. This is achieved by the use of the electrical and/or pneumatic socket sensors 909, 910 for detecting a presence or absence of the trailer-side pneumatic coupling 928 within the respective electrical or pneumatic park socket 950, 951. It is noted that, although both the electrical and pneumatic park sockets 950, 951 are described and shown herein as having a corresponding electrical or pneumatic socket sensor 909, 910, in some embodiments only one of the electrical or pneumatic park socket 950, 951 may include a corresponding electrical or pneumatic socket sensor 909, 910.

The electrical and pneumatic socket sensors 909, 910 can generally be any sensor or combination of sensors suitable for detecting a presence or absence of the respective trailer-side connector plug 929 or trailer-side pneumatic coupling 928 in the respective electrical or pneumatic park socket 950, 951. Such sensors can include, for example, a resistive element, a series connected diode and resistor, an inductive sensor, a magnetic proximity sensor, a microswitch proximity detector, any other suitable sensor, or combinations thereof. Several exemplary configurations of the electrical and pneumatic socket sensors 909, 910 are described in further detail above with reference to FIGS. 3A-3B, 4A-4B, 5, 6A-6B, 7A-7B, and 8.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

What is claimed is:

1. A park socket system for drive-off prevention comprising:
a park socket positioned on a tractor and sized to receive at least one of a trailer-side connector plug of a connector cable and/or a trailer-side pneumatic coupling of a pneumatic line;
a socket sensor configured to detect a presence or absence of the trailer-side connector plug and/or pneumatic coupling in the park socket;
a tractor controller configured, responsive to a detected absence of the trailer-side connector plug and/or pneumatic coupling within the park socket, to restrict movement of the tractor.

2. The park socket system of claim 1, wherein the tractor controller is configured to restrict movement of the tractor by at least one of preventing a gear change of the tractor, engaging a brake of the tractor, preventing an engine ignition of the tractor, prompting a driver of the tractor to provide driver feedback confirming disconnection of the trailer-side connector plug and/or pneumatic coupling from a trailer to be disconnected from the tractor, prompting a driver of the tractor to provide driver feedback confirming secure disconnected storage of the trailer-side connector plug and/or pneumatic coupling on the tractor after disconnection from the trailer, or combinations thereof.

3. The park socket system of claim 1, wherein the socket sensor is one or more of directly wired to the tractor controller, connected to the tractor controller via a wired network connection, connected to the tractor controller via a wireless connection, or combinations thereof.

4. The park socket system of claim 1, further comprising a communication module, wherein the communication module is one or more of directly wired to the tractor controller, connected to the tractor controller via a wired network connection, connected to the tractor controller via a wireless connection, or combinations thereof.

5. The park socket system of claim 1, wherein the park socket is positioned on a rear exterior surface, a side exterior surface, a lower exterior surface, or an upper exterior surface of the tractor.

6. The park socket system of claim 5, wherein the park socket is oriented in any upward-facing, downward-facing, side-facing, rear-facing, or angled direction relative to the tractor.

7. The park socket system of claim 1, wherein:
the trailer-side connector plug includes a plurality of trailer-side connector plug contacts; and
the park socket includes a number of socket contacts less than, equal to, or greater than a number of the plurality of electrical contacts of the trailer-side connector plug.

8. The park socket system of claim 1, wherein the park socket does not include electrical contacts.

9. The park socket system of claim 1, wherein the park socket includes a complementary pneumatic coupling to the trailer-side pneumatic coupling.

10. The park socket system of claim 1, wherein the socket sensor includes one or more of a resistive element connected between at least two electrical contacts of the park socket, the resistive element and a diode connected in series between at least two electrical contacts of the park socket, an inductive sensor positioned to detect, at the trailer-side connector plug and/or the trailer-side pneumatic coupling, a magnetic proximity sensor positioned to detect the trailer-side connector plug and/or the trailer-side pneumatic coupling, a microswitch proximity sensor positioned to detect the trailer-side connector plug and/or the trailer-side pneumatic coupling, an electrical continuity tester connected to two or more electrical contacts of the park socket and/or two points on a metallic element of the trailer-side pneumatic coupling, or combinations thereof.

11. The park socket system of claim 1, wherein the tractor controller is configured to determine a hitched or unhitched status of a trailer to be disconnected from the tractor.

12. The park socket system of claim 11, wherein the tractor controller is further configured, responsive to a detected absence of the trailer-side connector plug and/or the trailer-side pneumatic coupling within the park socket and a determined hitched status of the trailer to be disconnected, to restrict movement of the tractor.

13. The park socket system of claim 1, wherein the trailer-side connector plug is one of a single pole plug, a dual pole plug, a seven-way plug, a thirteen-way plug, a fifteen-way plug, or a seventeen-way plug.

14. The park socket system of claim 1, wherein the tractor controller is a tractor-side electronic control module configured for monitoring, tracking, and/or control over one or more of pneumatic systems and connections, electrical systems and connections, engine performance, emissions, transmission operation, braking systems, safety systems, lighting systems, connectivity between the tractor and the trailer, trailer control signaling, driver clutch use, driver use of cruise control, driver braking habits, driver acceleration habits, speed, tire pressure, or combinations thereof.

15. A park socket assembly for drive-off prevention comprising:
a housing;
a park socket positioned within the housing and sized to receive a trailer-side connector plug of a connector cable and/or a trailer-side pneumatic coupling of a pneumatic line;
a socket sensor configured to detect a presence or absence of the trailer-side connector plug in the park socket and/or the trailer-side pneumatic coupling; and
a communication module positioned within the housing for electronic communication with a tractor controller configured, responsive to a detected absence of the trailer-side connector plug and/or the trailer-side pneumatic coupling within the park socket, to restrict movement of a tractor.

16. The park socket assembly of claim 15, wherein the communication module is one or more of directly wirable to the tractor controller, connectable to the tractor controller via a wired network connection, connectable to the tractor controller via a wireless connection, or combinations thereof.

17. The park socket assembly of claim 15, wherein:
the trailer-side connector plug includes a plurality of trailer-side connector plug contacts; and
the park socket includes a number of socket contacts less than, equal to, or greater than a number of the plurality of electrical contacts of the trailer-side connector plug.

18. The park socket assembly of claim 15, wherein the park socket does not include electrical contacts.

19. The park socket assembly of claim 15, wherein the park socket includes a complementary pneumatic coupling to the trailer-side pneumatic coupling.

20. The park socket assembly of claim 15, wherein the socket sensor includes one or more of a resistive element connected between at least two electrical contacts of the park socket, the resistive element and a diode connected in series between at least two electrical contacts of the park socket, an inductive sensor positioned to detect, at the trailer-side connector plug and/or the trailer-side pneumatic coupling, a magnetic proximity sensor positioned to detect the trailer-side connector plug and/or the trailer-side pneumatic coupling, a microswitch proximity sensor positioned to detect the trailer-side connector plug and/or the trailer-side pneumatic coupling, an electrical continuity tester connected to two or more electrical contacts of the park socket and/or two points on a metallic element of the trailer-side pneumatic coupling, or combinations thereof.

21. The park socket assembly of claim 15, wherein the socket sensor is at least partially located within the housing.

22. The park socket assembly of claim 15, wherein the housing is configured to be installed on the tractor by one or more of mechanical fasteners, adhesives, welding, or combinations thereof.
